(19) United States
(12) Patent Application Publication
(10) Pub. No.: US 2025/0216366 A1
(43) Pub. Date: Jul. 3, 2025

(54) INSPECTION METHOD OF ELONGATED COATED SHEET

(71) Applicants: TOYOTA JIDOSHA KABUSHIKI KAISHA, Toyota-shi (JP); PANASONIC HOLDINGS CORPORATION, Osaka (JP)

(72) Inventors: Masahiro IWASAKI, Toyota-shi (JP); Yusuke ITO, Kashihara-shi (JP); Izuru SASAKI, Kyoto-shi (JP)

(73) Assignees: TOYOTA JIDOSHA KABUSHIKI KAISHA, Toyota-shi (JP); PANASONIC HOLDINGS CORPORATION, Osaka (JP)

(21) Appl. No.: 18/991,799

(22) Filed: Dec. 23, 2024

(30) Foreign Application Priority Data
Dec. 27, 2023 (JP) 2023-221668

(51) Int. Cl. G01N 31/16; H01M 10/0562

(52) U.S. Cl. CPC G01N 31/168; H01M 10/0562; H01M 2300/0068

(57) ABSTRACT

An inspection method of an elongated coated sheet including: (i) at a starting end position located at a position of a starting-end predetermined distance from a coating starting end, measuring a starting-end moisture amount and comparing the starting-end moisture amount with a starting-end specified value; (ii) at a terminal end position located at a position of a terminal-end predetermined distance from a coating terminal end, measuring a terminal-end moisture amount and comparing the terminal-end moisture amount with a terminal-end specified value; and (iii) when the starting-end moisture amount is smaller than the starting-end specified value and the terminal-end moisture amount is smaller than the terminal-end specified value, regarding the elongated coated sheet between the starting end position and the terminal end position as an acceptable product.

### CROSS-REFERENCE TO RELATED APPLICATION

This application claims priority to Japanese Patent Application No. 2023-221668 filed on Dec. 27, 2023. The disclosure of the above-identified application, including the specification, drawings, and claims, is incorporated by reference herein in its entirety.

### BACKGROUND

### 1. Technical Field

The present disclosure relates to an inspection method of an elongated coated sheet.

### 2. Description of Related Art

A solid-state battery is a secondary battery including a solid electrolyte as an electrolyte, and has been attracting attention for being highly safe compared with a liquid-based battery that uses an electrolytic solution as an electrolyte. In some solid-state batteries, the solid electrolyte is contained not only in a solid electrolyte layer but also in an electrode active material layer. For example, in manufacturing of a solid-state battery, from the viewpoint of production efficiency, the electrode active material layer or the solid electrolyte layer is applied to an elongated sheet substrate to produce an elongated coated sheet. When moisture is present in the elongated coated sheet, the solid electrolyte contained in the solid electrolyte layer or the electrode active material layer reacts with the moisture, which may lead to a decrease in the ion conductivity of the solid electrolyte. As a countermeasure, a manufacturing method of an all-solid-state battery as follows has been disclosed.

For example, Japanese Unexamined Patent Application Publication No. 2013-201111 (JP 2013-201111 A) discloses a manufacturing method of an all-solid-state battery having a positive electrode layer, a negative electrode layer, and a solid electrolyte layer provided between the positive electrode layer and the negative electrode layer. This manufacturing method of an all-solid-state battery has: a first step of producing the positive electrode layer, the negative electrode layer, and the solid electrolyte layer; a dewatering step of, for at least one of the positive electrode layer, the negative electrode layer, and the solid electrolyte layer that contains a solid electrolyte, performing a dewatering process on the solid electrolyte; and a lamination step of providing the solid electrolyte layer between the positive electrode layer and the negative electrode layer. JP 2013-201111 A says that it can provide a storage method and a storage device of a solid electrolyte that can mitigate deterioration of a solid electrolyte, as well as a manufacturing method of an all-solid-state battery that can manufacture an all-solid-state battery in which performance degradation is mitigated.

### SUMMARY

In manufacturing of a solid-state battery, a solid electrolyte deteriorates on reaction with moisture, which makes it necessary to inspect a moisture amount in an elongated coated sheet obtained by applying a solid electrolyte layer or an electrode active material layer to an elongated sheet substrate. However, when actually inspecting the moisture amount in an elongated coated sheet containing a solid electrolyte, performing a total inspection may take time, while performing a sampling inspection may result in variation among inspection sites.

Therefore, an object of the present disclosure is to provide an inspection method of an elongated coated sheet that can determine whether a moisture amount in a product part is allowable or not.

The present disclosure achieves the above object by the following solutions.

### <Aspect 1>

An inspection method of an elongated coated sheet having an elongated sheet substrate shaped into a roll and an electrode active material layer and/or a solid electrolyte layer applied to the elongated sheet substrate, the method including:
(i) at a first starting end position located at a position of a first-starting-end predetermined distance from a coating starting end, measuring a first-starting-end moisture amount and comparing the first-starting-end moisture amount with a first-starting-end specified value;
(ii) at a first terminal end position located at a position of a first-terminal-end predetermined distance from a coating terminal end, measuring a first-terminal-end moisture amount and comparing the first-terminal-end moisture amount with a first-terminal-end specified value; and
(iii) when the first-starting-end moisture amount is smaller than the first-starting-end specified value and the first-terminal-end moisture amount is smaller than the first-terminal-end specified value, regarding the elongated coated sheet between the first starting end position and the first terminal end position as an acceptable product.

### <Aspect 2>

The method according to Aspect 1, wherein the electrode active material layer and/or the solid electrolyte layer contains a sulfide solid electrolyte.

### <Aspect 3>

The method according to Aspect 1 or 2, wherein the first-starting-end predetermined distance is longer than the first-terminal-end predetermined distance.

### <Aspect 4>

The method according to any one of Aspects 1 to 3, further including, when the first-starting-end moisture amount is larger than the first-starting-end specified value, measuring a second-starting-end moisture amount at a second starting end position that is farther away from the coating starting end than the first starting end position is, and comparing the second-starting-end moisture amount with a second-starting-end specified value.

### <Aspect 5>

The method according to any one of Aspects 1 to 4, further including, when the first-terminal-end moisture amount is larger than the first-terminal-end specified value, measuring a second-terminal-end moisture amount at a second terminal end position that is farther away from the coating terminal end than the first terminal end position is, and comparing the second-terminal-end moisture amount with a second-terminal-end specified value.

### <Aspect 6>

A manufacturing method of a battery including the method according to any one of Aspects 1 to 5.

The inspection method of an elongated coated sheet of the present disclosure can determine whether a moisture amount in a product part is allowable or not.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a graph showing a relationship between a moisture amount and a measurement position in an elongated coated sheet; and

FIG. 2 is a schematic view for describing an inspection method of an elongated coated sheet of the present disclosure.

### DETAILED DESCRIPTION OF EMBODIMENTS

An embodiment of the present disclosure will be described in detail below. Note that the present disclosure is not limited to the following embodiment and can be implemented with various changes made thereto within the scope of the gist of the disclosure. In description of the drawings, the same elements will be denoted by the same reference signs and overlapping description thereof will be omitted.

Regarding the present disclosure, a “composite material” means a composition that can constitute an electrode active material layer etc. as is or by further containing other ingredient.

### Inspection Method of Elongated Coated Sheet

An inspection method of an elongated coated sheet of the present disclosure is:
an inspection method of an elongated coated sheet having an elongated sheet substrate shaped into a roll and an electrode active material layer and/or a solid electrolyte layer applied to the elongated sheet substrate, the method including:
   (i) at a first starting end position located at a position of a first-starting-end predetermined distance from a coating starting end, measuring a first-starting-end moisture amount and comparing the first-starting-end moisture amount with a first-starting-end specified value;
   (ii) at a first terminal end position located at a position of a first-terminal-end predetermined distance from a coating terminal end, measuring a first-terminal-end moisture amount and comparing the first-terminal-end moisture amount with a first-terminal-end specified value; and
   (iii) when the first-starting-end moisture amount is smaller than the first-starting-end specified value and the first-terminal-end moisture amount is smaller than the first-terminal-end specified value, regarding the elongated coated sheet between the first starting end position and the first terminal end position as an acceptable product.

The inspection method of an elongated coated sheet of the present disclosure can determine whether a moisture amount in a product part is allowable or not.

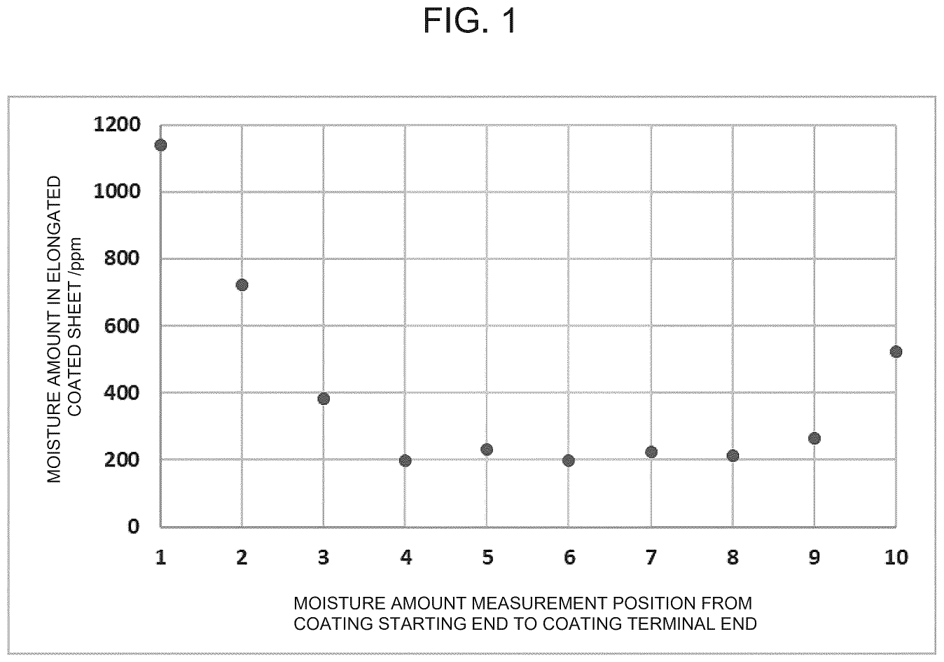

The present disclosers found that when, in manufacturing of an elongated coated sheet, a moisture amount at each position from a coating starting end to a coating terminal end of the elongated coated sheet was measured and a graph was created with the moisture amount and the measurement position plotted on a vertical axis and a horizontal axis, respectively, a curvilinear relationship that was convex downward (specifically, e.g., FIG. 1) was obtained. While this is not limited to theory, when a first-starting-end moisture amount at a first starting end position located at a first-starting-end predetermined distance from the coating starting end and a first-terminal-end moisture amount at a first terminal end position located at a first-terminal-end predetermined distance from a coating terminal end are smaller than a specified value, it is expected, from the aforementioned relationship between the moisture amount and the measurement position, that the moisture amount in the elongated coated sheet between the first starting end position and the first terminal end position is smaller than the specified value. Thus, whether the moisture amount in the product part is allowable or not can be determined from the moisture amount at a point other than the product part.

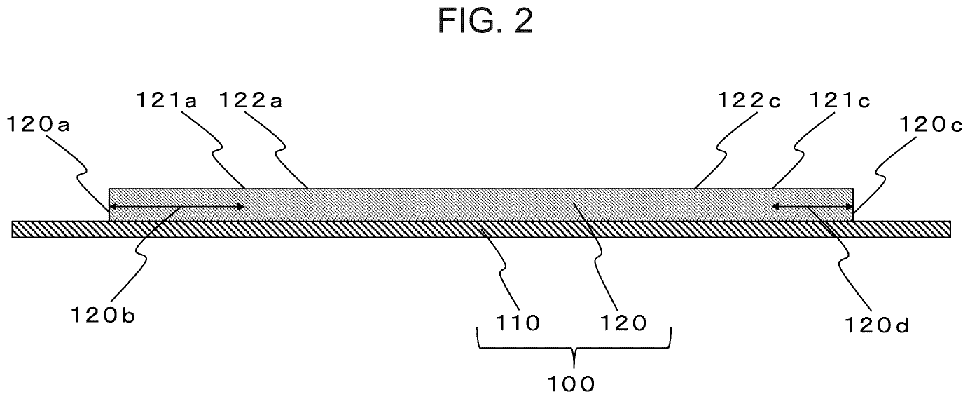

FIG. 2 is a schematic view showing one aspect of the inspection method of an elongated coated sheet of the present disclosure, but the inspection method is not limited to this case.

An elongated coated sheet 100 is obtained by applying an electrode active material layer and/or a solid electrolyte layer 120 to an elongated sheet substrate 110. In the inspection method of the elongated coated sheet 100, first, at a first starting end position 121a located at a position of a first-starting-end predetermined distance 120b from a coating starting end 120a, a first-starting-end moisture amount is measured and compared with a first-starting-end specified value. Next, at a first terminal end position 121c located at a position of a first-terminal-end predetermined distance 120d from a coating terminal end 120c, a first-terminal-end moisture amount is measured and compared with a first-terminal-end specified value. Then, when the first-starting-end moisture amount is smaller than the first-starting-end specified value and the first-terminal-end moisture amount is smaller than the first-terminal-end specified value, the elongated coated sheet between the first starting end position 121a and the first terminal end position 121c is regarded as an acceptable product. The inspection method of an elongated coated sheet of the present disclosure can determine whether the moisture amount in a product part like the elongated coated sheet between the first starting end position 121a and the first terminal end position 121c is allowable or not from the moisture amount at a point other than the product part like the first starting end position 121a or the first terminal end position 121c.

Note that, due to the influence of moisture in a bobbin or moisture in the elongated sheet substrate, the moisture amount in the elongated coated sheet tends to be large on the side of the coating starting end. Therefore, while not particularly limited, the first-starting-end predetermined distance 120b may be longer than the first-terminal-end predetermined distance 120d. Here, regarding the influence of the moisture in the elongated sheet substrate, in the elongated sheet substrate before being coated, the coating starting end is located in an outer circumference of the roll. For this reason, at the coating starting end, moisture is likely to be adsorbed onto a foil surface, so that the moisture amount in the elongated coated sheet tends to become large.

The inspection method of an elongated coated sheet of the present disclosure may further include, when the first-starting-end moisture amount is larger than the first-starting-end specified value, measuring a second-starting-end moisture amount at a second starting end position that is farther away from the coating starting end than the first starting end position is, and comparing the second-starting-end moisture amount with a second-starting-end specified value.

In FIG. 2 described above, when the first-starting-end moisture amount at the first starting end position 121a is larger than the first-starting-end specified value, the second-starting-end moisture amount at a second starting end position 122a that is farther away from the coating starting end 120a than the first starting end position 121a is, is measured. Next, the second-starting-end moisture amount and the second-starting-end specified value are compared. When the moisture amount at the first starting end position 121a is larger than the starting-end specified value, for example, the inspection position is shifted toward a center side of the elongated coated sheet until the moisture amount becomes smaller than the starting-end specified value, i.e., shifted to a point farther away from the coating starting end 120a than the first starting end position 121a is. Thus, a product part of an acceptable product, i.e., a product part in which the moisture amount in the elongated sheet is smaller than the specified value can be determined from the above-described relationship between the moisture amount and the measurement position. While not particularly limited, the second-starting-end specified value is preferably the same as the first-starting-end specified value.

In addition, the inspection method of an elongated coated sheet of the present disclosure may further include, when the first-terminal-end moisture amount is larger than the first-terminal-end specified value, measuring a second-terminal-end moisture amount at a second terminal end position that is farther away from the coating terminal end than the first terminal end position is, and comparing the second-terminal-end moisture amount with a second-terminal-end specified value.

In FIG. 2 described above, when the first-terminal-end moisture amount at the first terminal end position 121c is larger than the first-terminal-end specified value, the second-terminal-end moisture amount at a second terminal end position 122c that is farther away from the coating terminal end 120c than the first terminal end position 121c is, is measured. Next, the second-terminal-end moisture amount and the second-terminal-end specified value are compared. When the moisture amount at the first terminal end position 121c is larger than the terminal-end specified value, for example, the inspection position is shifted toward the center side of the elongated coated sheet until the moisture amount becomes smaller than the terminal-end specified value, i.e., shifted to a point farther away from the coating terminal end 120c than the first terminal end position 121c is. Thus, a product part of an acceptable product, i.e., a product part in which the moisture amount in the elongated sheet is smaller than the specified value can be determined from the above-described relationship between the moisture amount and the measurement position. While not particularly limited, the second-terminal-end specified value is preferably the same as the first-terminal-end specified value.

### Method of Measuring Moisture Amount

The moisture amount in the elongated coated sheet can be measured using a Karl Fischer device (a Karl Fischer device CA-310 and a moisture vaporizer VA-300 manufactured by Nittoseiko Analytech Co., Ltd.). Specifically, the moisture amount can be obtained by heating a positive electrode active material layer to 200° C. by the moisture vaporizer VA-300 and measuring moisture resulting from the heating by the Karl Fischer device CA-310.

### Inspection Method of Elongated Coated Sheet: Each Component

In the following, each component in the inspection method of an elongated coated sheet will be described.

### Elongated Coated Sheet

The elongated coated sheet has an elongated sheet substrate shaped into a roll and an electrode active material layer and/or a solid electrolyte layer applied to the elongated sheet substrate.

### Elongated Sheet Substrate

While a material used for the elongated sheet substrate is not particularly limited, a material that can be used as a positive electrode current collector or a negative electrode current collector of a battery can be adopted as appropriate. Examples of materials used for the elongated sheet substrate include Cu, Ni, Cr, Au, Pt, Ag, Al, Fe, Ti, Zn, Co, and stainless steel, but are not limited to these cases. The elongated sheet substrate may have, on a surface thereof, some kind of coating layer for a purpose such as adjusting the resistance. The elongated sheet substrate may be a metal foil or a substrate on which the aforementioned metal has been plated or vapor-deposited.

While the form of the elongated sheet substrate is not particularly limited, examples include a foil form, a plate form, and a mesh form. Among these, the foil form is preferable.

While the thickness of the elongated sheet substrate is not particularly limited, the thickness may be 0.1 μm or larger or 1 μm or larger and may be 1 mm or smaller or 100 μm or smaller.

### Electrode Active Material Layer

The electrode active material layer contains an electrode active material, and may further optionally contain a solid electrolyte, a conduction aid, a binder, etc. While not particularly limited, the electrode active material layer preferably contains a sulfide solid electrolyte. In addition, the electrode active material layer may contain various additives. The content of each of the electrode active material, the solid electrolyte, the conduction aid, the binder, etc. in the electrode active material layer may be appropriately determined according to the intended battery performance. For example, with the entire electrode active material layer (entire solid content) being 100 mass %, the content of the electrode active material may be 40 mass % or more, 50 mass % or more, or 60 mass % or more and may be 100 mass % or less or 90 mass % or less.

The electrode active material contained in the electrode active material layer may be a positive electrode active material or may be a negative electrode active material.

### Positive Electrode Active Material

The material of the positive electrode active material is not particularly limited as long as it can store and release lithium ions. Examples of positive electrode active materials include lithium cobaltate (LiCoO₂), lithium nickelate (LiNiO₂), lithium manganate (LiMn₂O₄), lithium nickel cobalt manganese oxide (NCM: LiCO_{1/3}Ni_{1/3}Mn_{1/3}O₂), lithium nickel cobalt aluminum oxide (LiNi_{0.8}(CoAl)_{0.2}O₂), and dissimilar element-substituted Li—Mn spinel with a composition represented by Li₁₊ₓMn_{2-x-y}M_{y}O₄ (where M is one or more types of metal elements selected from Al, Mg, Co, Fe, Ni, and Zn), but are not limited thereto.

While not particularly limited, the positive electrode active material may have a coated layer. The coated layer is a layer containing a substance that has lithium ion conductibility, has low reactivity with the positive electrode active material or the solid electrolyte, and can maintain the form of the coated layer without flowing on contact with the active material or the solid electrolyte. Other than LiNbO₃, specific examples of the material composing the coated layer include Li₄Ti₅O₁₂, Li₃PO₄, and a Li—Ti—Al—F-based material, but are not limited thereto.

The form of the positive electrode active material is not particularly limited. The positive electrode active material may have, for example, a particulate form. The positive electrode active material may be primary particles, or may be secondary particles into which a plurality of primary particles has clumped together. A mean particle diameter D₅₀ of the positive electrode active material may be, for example, 1 nm or larger, 5 nm or larger, or 10 nm or larger and may be 500 μm or smaller, 100 μm or smaller, 50 μm or smaller, or 30 μm or smaller. Note that, the mean particle diameter D₅₀ is a particle diameter (median diameter) at an integrated value of 50% in a particle size distribution on a volumetric basis obtained by a laser diffraction scattering method.

### Negative Electrode Active Material

As the negative electrode active material, various materials of which the potential for storing and releasing lithium ions (charging-discharging potential) is lower than that of the above-described positive electrode active material can be adopted. The material of the negative electrode active material is not particularly limited, and may be metallic lithium or may be a material that can store and release metal ions, such as lithium ions. Examples of materials that can store and release metal ions, such as lithium ions, include an alloy-based negative electrode active material, a carbon material, and lithium titanate (Li₄Ti₅O₁₂), but are not limited thereto.

The alloy-based negative electrode active material is not particularly limited, and examples include an Si-alloy-based negative electrode active material and an Sn-alloy-based negative electrode active material. Examples of the Si-alloy-based negative electrode active material include silicon, silicon oxide, silicon carbide, silicon nitride, and solid solutions of these. The Si-alloy-based negative electrode active material can include a metal element other than silicon, for example, Fe, Co, Sb, Bi, Pb, Ni, Cu, Zn, Ge, In, Sn, and Ti. Examples of the Sn-alloy-based negative electrode active material include tin, tin oxide, tin nitride, and solid solutions of these. The Sn-alloy-based negative electrode active material can include a metal element other than tin, for example, Fe, Co, Sb, Bi, Pb, Ni, Cu, Zn, Ge, In, Ti, and Si.

The carbon material is not particularly limited, and examples include hard carbon, soft carbon, and graphite.

The form of the negative electrode active material is not particularly limited. For example, the negative electrode active material may have a particulate form or may have a sheet form. The negative electrode active material may be primary particles, or may be secondary particles into which a plurality of primary particles has clumped together. A mean particle diameter D₅₀ of the negative electrode active material may be, for example, 1 nm or larger, 5 nm or larger, or 10 nm or larger and may be 500 μm or smaller, 100 μm or smaller, 50 μm or smaller, or 30 μm or smaller. Note that, the mean particle diameter D₅₀ is a particle diameter (median diameter) at an integrated value of 50% in a particle size distribution on a volumetric basis obtained by a laser diffraction scattering method.

### Solid Electrolyte

The material of the solid electrolyte is not particularly limited, and may be, for example, a sulfide solid electrolyte, an oxide solid electrolyte, or a polymer electrolyte.

Examples of the sulfide solid electrolyte include a sulfide-based amorphous solid electrolyte, a sulfide-based crystalline solid electrolyte, and an argyrodite-type solid electrolyte, but are not limited thereto. Specific examples of the sulfide solid electrolyte include a Li₂S—P₂S₅-based one (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₇S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, and combinations of these, but are not limited thereto.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ(LiPON), but are not limited thereto.

The sulfide solid electrolyte and the oxide solid electrolyte may be glass or may be crystallized glass (glass ceramic).

Examples of the polymer electrolyte include polyethylene oxide (PEO), polypropylene oxide (PPO), and copolymer of these, but are not limited thereto.

### Conduction Aid

The conduction aid is not particularly limited. The conduction aid may be, for example, vapor-grown carbon fiber (VGCF), acetylene black (AB), ketjenblack (KB), carbon nanotube (CNT), or carbon nanofiber (CNF), but is not limited thereto. The conduction aid may have, for example, a particulate form or a fiber form, and the size thereof is not particularly limited. One type of conduction aid may be used alone or two or more types of conduction aids may be used in combination, and the conduction aid is not particularly limited in this respect.

### Binder

The binder is not particularly limited. The binder may be, for example, a material such as polyvinylidene fluoride (PVdF), butadiene rubber (BR), polytetrafluoroethylene (PTFE), or styrene-butadiene rubber (SBR), but is not limited thereto. One type of binder may be used alone or two or more types of binders may be used in combination, and the binder is not particularly limited in this respect.

While the form of the electrode active material layer is not particularly limited, the electrode active material layer may be, for example, one having a sheet form with a substantially flat surface. While the thickness of the electrode active material layer is not particularly limited, the thickness may be, for example, 0.1 μm or larger, 1 μm or larger, or 10 μm or larger and may be 2 mm or smaller, 1 mm or smaller, or 500 μm or smaller.

The electrode active material layer can be manufactured by applying a commonly known method. For example, the electrode active material layer can be easily molded by molding an electrode composite material including the above-described various ingredients by a dry method or a wet method.

### Solid Electrolyte Layer

The solid electrolyte layer contains a solid electrolyte, and may further optionally contain a conduction aid, a binder, etc. While not particularly limited, the solid electrolyte layer preferably contains a sulfide solid electrolyte.

For the solid electrolyte, the conduction aid, and the binder, the description of “Electrode Active Material Layer” above can be referred to.

While the thickness of the solid electrolyte layer is not particularly limited, the thickness may be, for example, 0.1 μm or larger, 1 μm or larger, or 10 μm or larger and may be 2 mm or smaller, 1 mm or smaller, or 500 μm or smaller.

The solid electrolyte layer can be easily formed, for example, by molding a solid electrolyte composite material including the above-described solid electrolyte, binder, etc. by a dry method or a wet method.

### Manufacturing Method of Battery

A manufacturing method of a battery of the present disclosure may include the inspection method of an elongated sheet of the present disclosure.

The manufacturing method of a battery of the present disclosure can manufacture a battery from a member having a moisture amount smaller than a specified value.

### Battery

While not particularly limited, the battery may be a liquid-based battery that contains an electrolytic solution as an electrolyte layer, or may be a solid-state battery that has a solid electrolyte layer as an electrolyte layer. Note that, regarding the present disclosure, “solid-state battery” means a battery that uses at least a solid electrolyte as an electrolyte, and therefore the solid-state battery may use a combination of a solid electrolyte and a liquid electrolyte as an electrolyte. The battery may be an all-solid-state battery, i.e., a battery that uses only a solid electrolyte as an electrolyte.

The production method of a battery can specifically involve, for example: placing a solid electrolyte layer formed on an elongated sheet substrate onto a surface of a negative electrode active material layer formed on a negative electrode current collector serving as an elongated sheet substrate; performing pressing to transfer the solid electrolyte layer onto the surface of the negative electrode active material layer; peeling off the elongated sheet substrate that is in contact with the solid electrolyte layer; laminating the solid electrolyte layer onto the negative electrode active material layer; then placing a positive electrode active material layer formed on an elongated sheet substrate onto a surface of the solid electrolyte layer laminated on the negative electrode active material layer; performing pressing to transfer the positive electrode active material layer onto the solid electrolyte layer; peeling off the elongated sheet substrate that is in contact with the positive electrode active material layer; and laminating the positive electrode active material layer onto the solid electrolyte layer. However, the production method is not limited to this case.

The laminated body described above may be used as a battery, or a laminated body in which a positive electrode active material layer, a solid electrolyte layer, and a negative electrode active material layer are laminated may be provided with a positive electrode current collector layer and/or a negative electrode current collector layer as necessary, and this laminate may be enclosed to be used as a battery. While not particularly limited, the battery may be restrained under a restraining pressure of, for example, 5 MPa.

The present disclosure will be described in further detail with reference to Examples to be shown below, but the scope of the present disclosure is not limited to these Examples.

### Moisture Amount in Solid Electrolyte Layer

The moisture amount in the solid electrolyte layer was measured using a Karl Fischer device (a Karl Fischer device CA-310 and a moisture vaporizer VA-300 manufactured by Nittoseiko Analytech Co., Ltd.). Specifically, the moisture amount was obtained by heating the solid electrolyte layer to 200° C. by the moisture vaporizer VA-300 and measuring moisture resulting from the heating by the Karl Fischer device CA-310.

### Example 1

An elongated coated sheet having an elongated sheet substrate shaped into a roll and a solid electrolyte layer applied to the elongated sheet substrate was inspected. Here, the solid electrolyte layer is a solid electrolyte layer containing a sulfide solid electrolyte. Note that the first-starting-end specified value and the first-terminal-end specified value were 500 ppm. Example 1 will be described using FIG. 2.

### Comparison Between First-Starting-End Moisture Amount and First-Starting-End Specified Value

The first-starting-end moisture amount was measured at the first starting end position 121a located at the position of the first-starting-end predetermined distance 120b from the coating starting end 120a. The first-starting-end moisture amount was 382 ppm. Since the first-starting-end moisture amount was 382 ppm and the first-starting-end specified value was 500 ppm, the first-starting-end moisture amount was smaller than the first-starting-end specified value.

### Comparison Between First-Terminal-End Moisture Amount and First-Terminal-End Specified Value

The first-terminal-end moisture amount was measured at the first terminal end position 121c located at the position of the first-terminal-end predetermined distance 120d from the coating terminal end 120c. The first-terminal-end moisture amount was 266 ppm. Since the first-terminal-end moisture amount was 266 ppm and the first-terminal-end specified value was 500 ppm, the first-terminal-end moisture amount was smaller than the first-terminal-end specified value.

### Inspection Result of and Moisture Amount in Elongated Coated Sheet

Since the first-starting-end moisture amount was smaller than the first-starting-end specified value and the first-terminal-end moisture amount was smaller than the first-terminal-end specified value, the elongated coated sheet between the first starting end position 121a and the first terminal end position 121c was regarded as an acceptable product. Here, moisture amounts measured at four positions in the elongated coated sheet between the first starting end position 121a and the first terminal end position 121c were 197 ppm, 231 ppm, 212 ppm, and 225 ppm, all of which were smaller than 500 ppm that was the first-starting-end specified value and the first-terminal-end specified value. The moisture amount at the coating starting end 120a was 1143 ppm and the moisture amount at the coating terminal end 120c was 524 ppm, both of which were larger than 500 ppm that was the first-starting-end specified value and the first-terminal-end specified value. Thus, it was confirmed that whether a moisture amount in a product part like the elongated coated sheet between the first starting end position 121a and the first terminal end position 121c was allowable or not could be determined from a moisture amount at a point other than the product part like the first starting end position 121a or the first terminal end position 121c.

### Example 2

An elongated coated sheet having an elongated sheet substrate shaped into a roll and a solid electrolyte layer applied to the elongated sheet substrate was inspected. Here, the solid electrolyte layer is a solid electrolyte layer containing a sulfide solid electrolyte. The first-starting-end specified value, the second-starting-end specified value, and the first-terminal-end specified value were 500 ppm. Example 2 will be described using FIG. 2.

### Comparison Between First-Starting-End Moisture Amount and First-Starting-End Specified Value

The first-starting-end moisture amount was measured at the first starting end position 121a located at the position of the first-starting-end predetermined distance 120b from the coating starting end 120a. The first-starting-end moisture amount was 723 ppm. Since the first-starting-end moisture amount was 723 ppm and the first-starting-end specified value was 500 ppm, the first-starting-end moisture amount was larger than the first-starting-end specified value.

### Comparison Between Second-Starting-End Moisture Amount and Second-Starting-End Specified Value

Since the first-starting-end moisture amount was larger than the first-starting-end specified value, the second-starting-end moisture amount at the second starting end position 122a that was farther away from the coating starting end 120a than the first starting end position 121a was, was measured. The second-starting-end moisture amount was 382 ppm. Since the second-starting-end moisture amount was 382 ppm and the second-starting-end specified value was 500 ppm, the second-starting-end moisture amount was smaller than the second-starting-end specified value.

### Comparison Between First-Terminal-End Moisture Amount and First-Terminal-End Specified Value

The first-terminal-end moisture amount was measured at the first terminal end position 121c located at the position of the first-terminal-end predetermined distance 120d from the coating terminal end 120c. The first-terminal-end moisture amount was 266 ppm. Since the first-terminal-end moisture amount was 266 ppm and the first-terminal-end specified value was 500 ppm, the first-terminal-end moisture amount was smaller than the first-terminal-end specified value.

### Inspection Result of and Moisture Amount in Elongated Coated Sheet

Since the second-starting-end moisture amount was smaller than the second-starting-end specified value and the first-terminal-end moisture amount was smaller than the first-terminal-end specified value, the elongated coated sheet between the second starting end position 122a and the first terminal end position 121c was regarded as an acceptable product. Here, moisture amounts actually measured at four positions in the elongated coated sheet between the second starting end position 122a and the first terminal end position 121c were 197 ppm, 231 ppm, 212 ppm, and 225 ppm, all of which were smaller than 500 ppm that was the first-starting-end specified value, the second-starting-end specified value, and the first-terminal-end specified value. The moisture amount at the coating starting end 120a was 1143 ppm and the moisture amount at the coating terminal end 120c was 524 ppm, both of which were larger than 500 ppm that was the first-starting-end specified value, the second-starting-end specified value, the first-terminal-end specified value, and the second-terminal-end specified value. Thus, it was confirmed that whether a moisture amount in a product part like the elongated coated sheet between the second starting end position 122a and the first terminal end position 121c was allowable or not could be determined from a moisture amount at a point other than the product part like the second starting end position 122a or the first terminal end position 121c.

While a preferred embodiment of the inspection method of an elongated coated sheet of the present disclosure has been described, those skilled in the art understand that changes can be made without departing from the scope of the claims.

What is claimed is:

1. An inspection method of an elongated coated sheet having an elongated sheet substrate shaped into a roll and an electrode active material layer and/or a solid electrolyte layer applied to the elongated sheet substrate, the method comprising:
(i) at a first starting end position located at a position of a first-starting-end predetermined distance from a coating starting end, measuring a first-starting-end moisture amount and comparing the first-starting-end moisture amount with a first-starting-end specified value;
(ii) at a first terminal end position located at a position of a first-terminal-end predetermined distance from a coating terminal end, measuring a first-terminal-end moisture amount and comparing the first-terminal-end moisture amount with a first-terminal-end specified value; and
(iii) when the first-starting-end moisture amount is smaller than the first-starting-end specified value and the first-terminal-end moisture amount is smaller than the first-terminal-end specified value, regarding the elongated coated sheet between the first starting end position and the first terminal end position as an acceptable product.

2. The method according to claim 1, wherein the electrode active material layer and/or the solid electrolyte layer contains a sulfide solid electrolyte.

3. The method according to claim 1, wherein the first-starting-end predetermined distance is longer than the first-terminal-end predetermined distance.

4. The method according to claim 1, further comprising, when the first-starting-end moisture amount is larger than the first-starting-end specified value, measuring a second-starting-end moisture amount at a second starting end position that is farther away from the coating starting end than the first starting end position is, and comparing the second-starting-end moisture amount with a second-starting-end specified value.

5. The method according to claim 1, further comprising, when the first-terminal-end moisture amount is larger than the first-terminal-end specified value, measuring a second-terminal-end moisture amount at a second terminal end position that is farther away from the coating terminal end than the first terminal end position is, and comparing the second-terminal-end moisture amount with a second-terminal-end specified value.

6. A manufacturing method of a battery comprising the method according to claim 1.
